(19) United States
(12) Patent Application Publication
(10) Pub. No.: US 2015/0154508 A1
(43) Pub. Date: Jun. 4, 2015

(54) INDIVIDUALIZED DATA SEARCH

(71) Applicant: Alibaba Group Holding Limited, Grand Cayman (KY)

(72) Inventor: Xi Chen, Hangzhou (CN)

(21) Appl. No.: 14/554,775

(22) Filed: Nov. 26, 2014

(30) Foreign Application Priority Data
Nov. 29, 2013 (CN) 201310628812.6

(51) Int. Cl. G06N 99/00; G06N 5/04; G06F 17/30

(52) U.S. Cl. CPC G06N 99/005; G06F 17/3053; G06N 5/048

(57) ABSTRACT

A machine learning is conducted according to user behavior data to obtain a satisfaction degree of the user behavior data. One or more characteristics are selected from a characteristic of the user and a characteristic of the data object in the user behavior data to obtain a characteristic combination. Individualized model training is conducted according to the satisfaction degree of the user behavior data under each characteristic or characteristic combination to obtain an individualized weight of each characteristic or characteristic combination. One or more data objects searched according to a query word in a search request of the user is ranked based on the individualized weight of the characteristic or characteristic combination. The one or more searched data objects are displayed according to the ranking. The present techniques improve performance of a search platform, increase accuracy of search results, and output reasonable results that satisfies an intention of the user.

### CROSS REFERENCE TO RELATED PATENT APPLICATIONS

This application claims foreign priority to Chinese Patent Application No. 201310628812.6 filed on 29 Nov. 2013, entitled “Individualized Data Search Method and Apparatus,” which is hereby incorporated by reference in its entirety.

### TECHNICAL FIELD

The present disclosure relates to the field of data search, and, more particularly, to an individualized data search method and apparatus.

### BACKGROUND

Network data volume is increasing rapidly. A data search engine is becoming an important tool to help a user find a satisfactory data object from a massive amount of data objects. There are various methods to use the data search engine. The user may input a keyword for inquiry (query word) to find a search result (including data objects) matching the query word from the massive amount of data objects. No matter how the data search engine is used to search the data object, a key technique involves ranking and outputting all of the data objects in the search result. In other words, after the user inputs the query word, corresponding data objects are found through a search as the search result and the search result is ranked and displayed. Under the conventional techniques, the data search technique is irrelevant with the user or a characteristic of the user and only relates to the query word. In other words, different users would have the same data objects or search result if they use the same query word. In addition, the ranking of the displayed search result is also the same. Thus, different users would have the same search result if different users use the same query word for search.

If the same query word returns the same search result and ranking of the search result, the conventional techniques may not provide the most proper and accurate search result for the users having different characteristics. The conventional techniques may not provide the most accurate and satisfying result from the massive amount of data through the inquiry to the specific user. Thus, the search result is inaccurate and unsatisfactory with respect to the user. The search platform has low performance and efficiency and requires manually viewing massive amounts of data in the search result. Thus, a user behavior such as a subsequent viewing and visiting of the user also has low efficiency and the user behavior of the user to the search data objects is also reduced. The characteristic of the user is a characteristic of the user in each dimension, such as gender, age, job, and preference of the user.

An individualized search is becoming popular. The individualized search means that different users may obtain different search results. Specifically, if different users use the same query word to search, the search result is displayed according to different rankings corresponding to different users. The ranking takes the characteristic of the user in one or more dimensions into consideration. The dimensions of the user reflect personalities of the user. The dimensions include a gender dimension such as male or female, an age dimension such as child, youth, adult, senior, a network visiting frequency dimension such as high, middle, and low, an account dimension such as account A, account B, etc. In addition, the searched data objects may have different characteristics at different dimensions. For example, a category of the data object may be used as one of the dimensions, i.e., a category dimension. The characteristics of the data objects may include sports, culture, etc. As different users may have different characteristics at a certain dimension, the characteristics of the data objects that the user focuses on or pays attention to are also different. The data objects which the user pays attention to may be obtained from analyzing the user behavior data. The user behavior data may include any data related to a user behavior arising from an interaction between the user and the data object, such as a click, browsing, and interaction that the user applies to the data object. The individualized data search focuses on the user and conducts an individualized ranking of the data objects in the search result by reference to the characteristic of the user and the characteristics of the data objects according to the user behavior data, thereby satisfying the needs of different users to different data objects.

The conventional individualized search mainly uses the interaction between the user and the data objects as the target, conducts training based on the characteristics of the user in one or more dimensions and the characteristics of the data objects in one or more dimensions, obtains weights of the characteristics of the user and/or weights of the characteristics of the data objects, and predicts a respective possibility that the user may interact with each data object based on the weights. The probability may be used as a ranking score when the corresponding data object is ranked. When the search is conducted according to the query word input by the user, the search result (one or more data objects) from the search is ranked according to the respective possibility of the interaction with each data object from high to low and is displayed to the user. However, the attentions or preferences to the data objects reflected by different behavior data of the user are different. For example, the user clicks a particular data object, obtains detailed information of the particular data object, and finishes visiting a webpage without subsequent operation to the particular data object. In contrast, the user later clicks another data object, obtains detailed information of another data object, and saves the data object. In such example, the subsequent click behavior data of the user reflects more attention or preference from the user to the data object than the preceding click behavior data of the user does.

When the weight of the characteristic combination is calculated, the only possibility of data interaction for the particular “interaction” user behavior is used to rank the data objects in the search result while the influences of different behavior data of the user to the degree of the preference or attention of the user are ignored. Thus, the ranking accuracy of the search result is low and the performance of the individualized search of the search platform needs to be improved to increase the accuracy of the search result and provide the most reasonable result that satisfies the search intention to the user.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides an example individualized data search method and apparatus to improve a performance of individualized search, thereby providing a search result that satisfies a search intention of a user to a maximum extent and improving an accuracy of the search result output by a search platform.

The present disclosure provides the following present techniques. The present disclosure provides an example individualized data search method. A machine learning is conducted according to user behavior data that records one or more user behaviors of a user to one or more data objects to obtain a satisfaction degree of each user behavior data. A characteristic combination is formed by selecting one or more characteristics from a characteristic of the user and a characteristic of a data object in the user behavior data. Individualized model training is conducted according to the satisfaction degree of the user behavior data under each characteristic or characteristic combination to obtain an individualized weight of each characteristic or characteristic combination. One or more data objects searched according to a query word in a search request of the user is ranked based on an individualized weight of the characteristic or characteristic combination. The one or more searched data objects are displayed according to the ranking.

For example, each user behavior data may record at least the user, the one or more behaviors of the user to one or more data objects, the one or more data objects, and one or more query words corresponding to the one or more data objects. The machine learning conducted according to the user behavior data that records the one or more user behaviors of the user to the one or more data objects may include the following operation. The machine learning is conducted according to each recorded user behavior of the one or more user behaviors.

For example, the machine learning conducted according to the user behavior data that records the one or more user behaviors of the user to the one or more data objects to obtain the satisfaction degree of each user behavior data may include the following operations. The machine learning may include a training processing and a predicting processing. The training processing includes conducting a satisfaction degree model training according to each recorded user behavior of the one or more user behaviors and determining a satisfaction degree weight of each user behavior. The predicting processing includes predicting a satisfaction degree of each user behavior data according to the satisfaction degree weight of each recorded user behavior of the one or more user behaviors.

For example, the machine learning conducted according to the user behavior data that records the one or more user behaviors of the user to the one or more data objects to obtain the satisfaction degree of each user behavior data may include the following operations. The satisfaction degree of each user behavior data is normalized according to the user and the query words recorded in each user behavior data.

For example, the characteristic combination may be formed by selecting one or more characteristics from a characteristic of the user and a characteristic of a data object in the user behavior data according to the following operations. The characteristic of the user and the characteristic of data object recorded in each user behavior data is obtained according to pre-stored characteristic of the user and characteristic of the data object. The individualized model training conducted according to the satisfaction degree of the user behavior data each characteristic or characteristic combination to obtain the individualized weight of each characteristic or characteristic combination may include the following operations. The individualized weight of the characteristic of each data object with respect to the characteristic of each user is trained according to the satisfaction degree of each user behavior data, the characteristic of the data object, and the characteristic of the user recorded in each user behavior data.

For example, the ranking of one or more data objects searched according to the query word in the search request of the user based on the individualized weight of the characteristic or characteristic combination may include the following operations. The characteristic of the user is obtained based on the search request of the user. The characteristic of the data object is obtained corresponding to the searched data object. An individualized score of each data object is predicted through inquiring an individualized weight of the characteristic combination corresponding to the characteristic of the user and the characteristic of the data object. Based on the individualized score of each data object, the one or more data objects are ranked.

The present disclosure provides an example individualized data search apparatus which may include a learning module, a forming module, a training module, and a ranking module. The learning module conducts a machine learning according to user behavior data that records one or more user behaviors of a user to one or more data objects to obtain a satisfaction degree of each user behavior data. The forming module forms a characteristic combination by selecting one or more characteristics from a characteristic of the user and a characteristic of a data object in the user behavior data. The training module conducts individualized model training according to the satisfaction degree of the user behavior data under each characteristic or characteristic combination to obtain an individualized weight of each characteristic or characteristic combination. The ranking module ranks one or more data objects searched according to a query word in a search request of the user based on the individualized weight of the characteristic or characteristic combination and displays the one or more searched data objects according to the ranking.

For example, each user behavior data may record at least the user, the one or more behaviors of the user to one or more data objects, the one or more data objects, and one or more query words corresponding to the one or more data objects. The learning module may further conduct the machine learning according to each recorded user behavior of the one or more user behaviors.

For example, the learning module may include a training processing unit and a predicting processing unit. The training processing unit conducts a satisfaction degree model training according to each user behavior of the one or more user behaviors recorded in the user behavior data and determines a satisfaction degree weight of each user behavior. The predicting processing unit predicts a satisfaction degree of each user behavior data according to the satisfaction degree weight of each user behavior of the one or more user behaviors recorded in the user behavior data.

For example, the learning module may normalize the satisfaction degree of each user behavior data according to the user and the query words recorded in each user behavior data.

For example, the forming module may further obtain the characteristic of the user and the characteristic of data object recorded in each user behavior data according to pre-stored characteristic of the user and characteristic of the data object. The training module may further train the individualized weight of the characteristic of each data object with respect to the characteristic of each user according to the satisfaction degree of each user behavior data, the characteristic of the data object, and the characteristic of the user recorded in each user behavior data.

For example, the ranking module may obtain the characteristic of the user based on the search request of the user and the characteristic of the data object based on the searched data object, predict an individualized score of each data object through inquiring an individualized weight of the characteristic combination corresponding to the characteristic of the user and the characteristic of the data object, and ranks the one or more data objects based on the individualized score of each data object.

The present techniques form the satisfaction degree model based on the previous user behavior data and its recorded user, one or more data objects, and one or more user behaviors of the user to the one or more data objects and further form the individualized model. The present techniques use the individualized model to calculate the individualized score of each data object of the searched one or more data objects, rank the searched one or more data objects according to the individual score of each data object, and display the searched one or more data objects to the user according to the ranking. The present techniques improve the performance of the search platform, increase the accuracy of the search result output to the user, and provide the result that mostly reasonably satisfies the search intention of the user.

### BRIEF DESCRIPTION OF THE DRAWINGS

The FIGs are used to further illustrate the present disclosure and are a part of the present disclosure. The example embodiments and their explanations are used to illustrate the present disclosure and shall not be construed as a limit to the present disclosure.

FIG. 1 is a flowchart illustrating an example individualized data search method according to the present disclosure.

FIG. 2 is a flowchart illustrating an example satisfaction degree model training of an example individualized data search method according to the present disclosure.

FIG. 3 is a diagram illustrating an example individualized data search apparatus according to the present disclosure.

### DETAILED DESCRIPTION

The present techniques, according to recorded user behavior data, construct a satisfaction degree model to obtain a satisfaction degree of each user behavior data. The present techniques, according to each characteristic combination formed by a characteristic of a user corresponding to each user behavior data in one or more dimensions and a characteristic of a data object corresponding to each user behavior data in one or more dimensions, by combining with the satisfaction degree of each user behavior data, construct an individualized model to obtain an individualized weight of each characteristic combination. When conducting a data search according to a query word input by the user, with respect to found one or more data objects, the present techniques, according to the individualized weight of each characteristic combination, find a corresponding individualized weight of the characteristics of the user and the characteristic of each data object and calculate an individualized score of each data object searched by the user. The present techniques, according to the individualized score of each data object, rank the found one or more data objects and display the one or more objects according to a result of the ranking. The present techniques improve an accuracy of a search result output to the user and provide a most reasonable result to the user that mostly satisfies an intention of the user.

To clearly illustrate a purpose, a technical technique, and an advantage of the present disclosure, the present disclosure is described by reference to example embodiments and their accompanying FIGS. Certainly, the described embodiments are only a portion instead of all of the embodiments of the present disclosure. Based on the example embodiments of the present disclosure, one of ordinary skill in the art may obtain other embodiments without making creative efforts, which are also under the protection scope of the present disclosure.

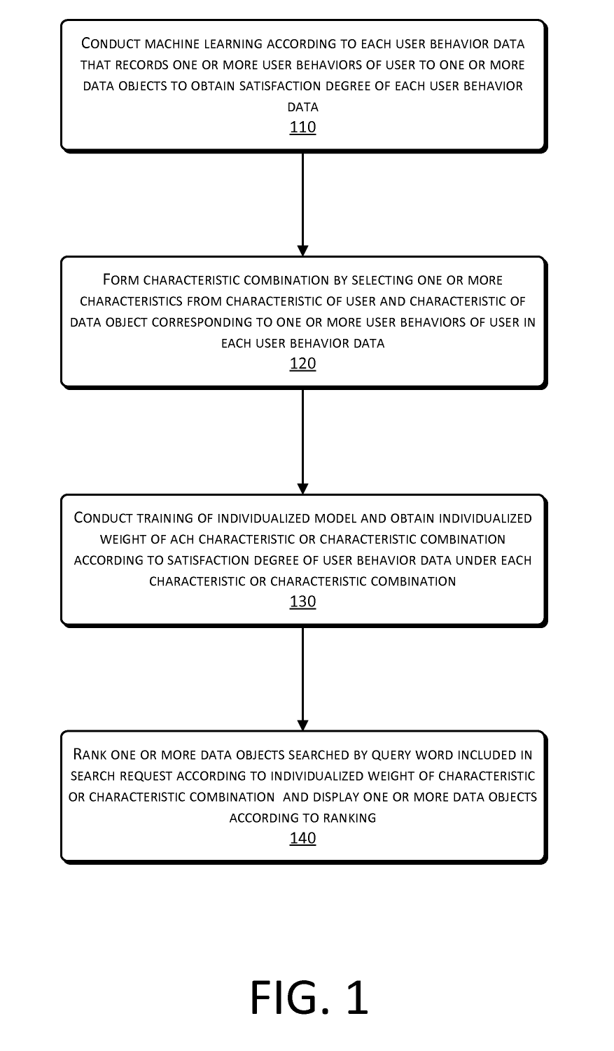

The present disclosure provides an example search result ranking method. FIG. 1 is a flowchart illustrating an example individualized data search method according to the present disclosure.

At 110, a machine learning is conducted according to each user behavior data that records one or more user behaviors of a user to one or more data objects to obtain a satisfaction degree of each user behavior data.

The user behavior is a behavior (operation or action) conducted by the user to a respective data object. There may be multiple behaviors that are conducted by the user to the data objects, such as clicking, viewing, saving the data object, viewing a staying time of the data object, data interaction based on the data object. Furthermore, the user behavior, such as data interaction, may be further divided into actions such as downloading and payment. The user obtains the one or more data objects matching a query word included in a search request through searching. The one or more data objects are used as a search result and output to the user that requests searching.

The user behavior data records one or more different types of user behaviors (i.e., one or more user behaviors) conducted by the user to the data objects. For example, the user behavior data may record the user, the one or more user behaviors conducted by the user to the data object, the data object, and the query word corresponding to the data object. A log file collected by a server may include one or more log data. Such one or more log data may be one or more user behavior data. One piece of user behavior data may include a series of user behaviors conducted by the user to the data object that starts from a time when the user starts to search the data object and after the data object is found.

For example, the machine learning may include a training processing and a predicting processing to obtain the satisfaction degree of each user behavior data. The satisfaction degree of the user behavior data refers to a satisfaction degree of the user to the data object in the user behavior data, and, more specifically, a probability of designated data interaction with respect to the recorded data object implemented by the user and recorded in the user behavior data. In an e-commerce system, the designated data interaction refers to a data interaction that the system expects the user to conduct, such as purchasing a product or making a payment. In other words, the machine learning process may include training the satisfaction degree model and using the satisfaction degree model to estimate or predict the satisfaction degree of the user to the data object in the user behavior data.

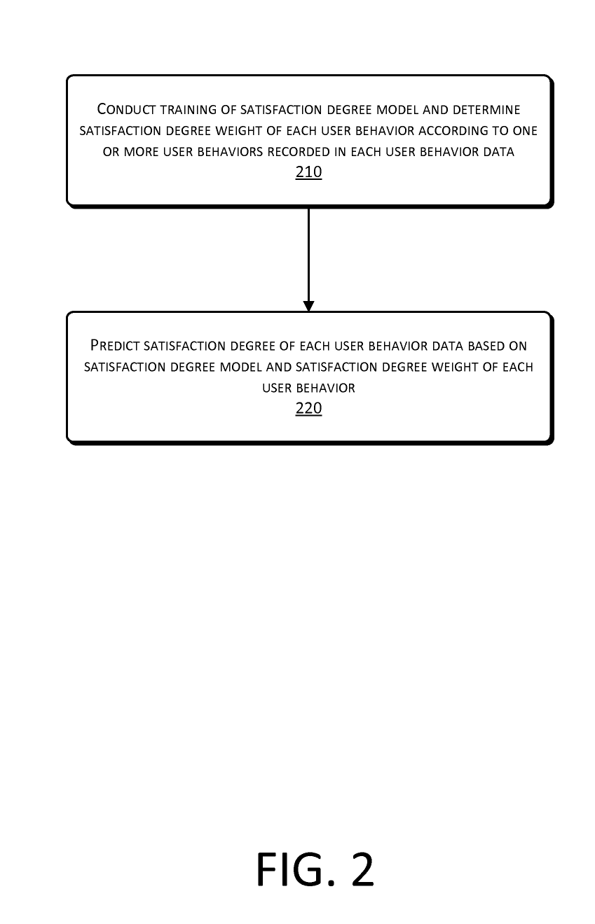

FIG. 2 is a flowchart illustrating an example training of the satisfaction degree model with respect to an example individualized data search method according to the present disclosure.

At 210, the training of the satisfaction degree model is conducted and a satisfaction degree weight of each user behavior is determined according to one or more user behaviors recorded in each user behavior data. The operations at 210 are an example training processing.

In the training processing, the server uses a series of related behaviors of the user (such as user operations in one session) and behavior characteristics (such as a number of behaviors or behavior times) recorded in the user behavior data as the characteristic (sample characteristic) of a training set. A training target is a designated behavior in the series of related behaviors. The satisfaction degree of the user behavior data in the training set may be preset or known.

The model training is conducted according to the characteristics in the training set to obtain the model that correctly predicts the satisfaction degree of the user behavior data or the satisfaction degree model. The model (rule) is trained and the parameters in the model are adjusted. If the satisfaction degree of the user behavior data calculated by the model matches the preset satisfaction degree of the user behavior data (such that an error is within a preset range), such model is the satisfaction degree model obtained through training.

The server may use the designated data interaction that the user implements to the data object as the target for training the satisfaction degree model. The satisfaction degree model is trained according to the recorded user behavior data to obtain the satisfaction degree weight of each user behavior.

For example, the training of the satisfaction degree model and obtaining the satisfaction degree weight may include the following operations. A machine learning model is selected and one or more parameters of the model are obtained according to the training of the labeled sample set. Each parameter corresponds to one user behavior. The model is trained by using one or more user behaviors and their characteristics included in the user behavior data that is already labeled satisfaction degree or the characteristics of the training set. That is, the present techniques verify whether the satisfaction degree of the user behavior data predicted by the model is correct. If the predicted satisfaction degree is not correct, the model and its parameters are adjusted until the satisfaction degree predicted by the model is correct. The adjusted model is used as the satisfaction degree model to finally predict the satisfaction degree of the user behavior data. The parameters contained in the model are used as the corresponding satisfaction degree weights of the user behaviors.

The satisfaction degree weight (wm) of the user behavior may reflect an importance of the type of the user behavior that is learned during the process of training the target (such as completing the designated data interaction behavior). The satisfaction degree weight is the parameter of the satisfaction degree model. For example, the importance of the type of the user behavior may refer to a probability to successfully implement the training target based on an occurrence of the type of the user behavior. For instance, the satisfaction degree weight (wm)=a number of times that a training target G is realized on the condition of an occurrence of a user behavior A/a total number of times of occurrences the user behavior A. The higher the satisfaction degree weight of the user behavior is, the higher the possibility that the training target is realized is. The lesser the satisfaction degree weight of the user behavior is, the lower the possibility that the training target is realized is.

Using an example of online shopping that requires massive data searching, when the user conducts online shopping, the user inputs a query and receives a list of products. The list of products is composed of one or more found data objects (products). The types of user behaviors include viewing the list of products, clicking a product, viewing a detailed page of the product, purchasing the product, or any designated data interaction. The series of the user behaviors is recorded in a log file.

For example, Table 1 shows an example log file that records the user behavior data. However, the log file is not restricted to contents in Table 1.

TABLE 1

| | | | | | | Number | |
|---|---|---|---|---|---|---|---|
| | | | | Number | | of Times | |
| | | | | of | | to add | Number |
| | | | | Times | Number | into | of Times |
| Ser. | Data | | | to | of times | shopping | to |
| No | Object | User | Query | Display | to Click | cart | Purchase |
| 1 | Product | User | Q1 | 1 | 1 | 1 | 1 |
| | A1 | U1 | | | | | |
| 2 | Product | User | Q1 | 1 | 1 | 0 | 0 |
| | A1 | U2 | | | | | |
| 3 | Product | User | Q2 | 1 | 0 | 0 | 0 |
| | A1 | U1 | | | | | |
| 4 | Product | User | Q2 | 1 | 1 | 0 | 1 |
| | A2 | U1 | | | | | |

The log file includes four user behavior data. The user behavior data records a serial number, a found data object through search (such as a product A1 or a product A2), a user who inputs a query word (such as a user U1 or a user U2), the query word (such as a query word Q1 or a query word Q2), and a number of user behaviors that the user generates with respect to the data object through a search. For example, the log file records four user behaviors including displaying, clicking, adding into a shopping cart, and purchasing and a number of times of each user behavior in the user behavior data, such that a number of times to display is 1, a number of times to click is 1, a number of times to add the product into the shopping cart is 1, and a number of times to purchase is 1. The types of user behaviors in the user behavior data may be increased or reduced upon needs.

The log file records all user behavior data. A proportion that a respective user behavior is finally realized is considered to determine a respective satisfaction degree weight of the respective user behavior. For example, the user behavior “purchase” that represents data interaction in Table 1 may be used as a target for training the satisfaction degree model. According to all user behavior data listed in Table 1, an importance of each user behavior (or studied user behavior) in implementing the process of purchasing is calculated. Different kinds of user behaviors may be extracted from the log file. For example, the four user behaviors include displaying, clicking, adding into a shopping cart, and purchasing may be extracted from Table 1. According to the extracted user behaviors, the purchase is used as the target for training of the satisfaction degree model to calculate the satisfaction degree weight of each user behavior.

In a simple calculation example as shown in Table 1, a total number of times to display products (data objects) is 4. Among the users who display the products, a number of purchasing is 2. Thus, a satisfaction degree weigh of purchasing is 0.5 (2/4=0.5). A number of times of clicking the products is 3. Among the users who click the products, a number of purchasing is 2. Thus, a satisfaction degree weigh of clicking is 0.67 (2/3≈0.67). A number of times of adding the products in the shopping cart is 1. Among the users who add the products in the shopping cart, a number of purchasing is 1. Thus, a satisfaction degree of adding the product into the shopping cart is 1 (1/1=1). A number of times of purchasing the products is 2. Thus, the satisfaction degree of purchasing is 1 (2/2=1).

For example, the training of the satisfaction degree model may be conducted through methods such as logical regression, decision tree, etc. For instance, the logical regression or the decision tree may be used to construct the model (rule) to be trained and start training, such as the logical regression model training or decision tree model training, to obtain a final satisfaction degree model and a satisfaction degree weight of each user behavior.

For another example, a portion of the user behavior data is extracted from the log file as the training sample to conduct training of the satisfaction degree model and the satisfaction degree weight of each user behavior in the portion of the user behavior data is obtained. For instance, a half (50%) of the use behavior data is randomly selected from the log file to train the satisfaction degree weight of each user behavior. Two pieces of user behavior data with serial no 1 and serial no 2 (50% of the user behavior data) is randomly extracted from the Table 1 and pieces of user behaviors data with serial no 3 and serial no 4 are ignored. The satisfaction degree weight of each user behavior is obtained based on the extracted two pieces of user behavior data.

At 220, the satisfaction degree of each user behavior data is predicted based on the satisfaction degree model and the satisfaction degree weight of each user behavior. The operations at 220 are example predicting processing. The predicting processing is the predicting process of the satisfaction degree model.

The prediction of the satisfaction degree of the user behavior data is to predict the probability of data interaction that the user implements with respect to the data object in the user behavior data. The user behavior data for implementing the data interaction is used as the user behavior data with the highest satisfaction degree.

For example, one or more user behaviors of the user with respect to the data object may be used as the user behavior chain, such as clicking the data object, a time to view the data object, a data interaction with respect to the data object. Further, the user behaviors of the data may be used to determine a satisfaction/preference degree of the user to the data object. The higher the satisfaction/preference degree of the user to the data object is, the higher the possibility of implementing data interaction is.

The prediction of the satisfaction degree of the user behavior data may be based on the satisfaction degree weight of one or more user behaviors and the one or more user behaviors in the user behavior data recorded in the log file. The satisfaction degree of the user behavior data is calculated accordingly.

For example, formula (1.1) may be used to calculate the satisfaction degree of each user behavior data in Table 1.

$$P V R = \frac{1}{1 + {e}^{- ( fm 1 \times wm 1 + fm 2 \times wm 2 + … + fmn \times wmn )}} \qquad ( 11 )$$

fm (fm1, fm2, . . . , fmn) is a characteristic volume. fm may be represented by a value. In this example, fm is a number of each user behaviors (times) in the one or more user behaviors included in the user behavior data. wm (wm1, wm2, . . . , wmn) is used to represent a satisfaction degree weight corresponding to each user behavior. The formula (1.1) may be used as the satisfaction degree model. The satisfaction degree weight is a parameter used in the satisfaction degree model.

The satisfaction degree model is used to predict the satisfaction degree of the user behavior data. As shown in Table 1, among the user behaviors listed in Table 1, the satisfaction degree weight of the displaying behavior is 0.5, the satisfaction degree weight of the clicking behavior is 0.67, the satisfaction degree weight of the behavior that adds the product into the shopping cart is 1, and the satisfaction degree of the purchasing behavior is 1.

Through the calculation of the formula (1), following results are obtained.

The satisfaction degree of the user behavior with serial no 1 (PRV1) is:

$$P V R 1 = \frac{1}{1 + {e}^{- ( 1 \times 0.5 + 1 \times 0.67 + 1 \times 1 + 1 \times 1 )}} = 0.96$$

The satisfaction degree of the user behavior with serial no 2 (PRV2) is:

$$P V R 2 = \frac{1}{1 + {e}^{- ( 1 \times 0.5 + 1 \times 0.67 + 0 \times 1 + 0 \times 1 )}} = 0.76$$

The satisfaction degree of the user behavior with serial no 3 (PRV3) is:

$$P V R 3 = \frac{t}{1 + {e}^{- ( 1 \times 0.5 + 0 \times 0.67 + 0 \times 1 + 0 \times 1 )}} = 0.62$$

The satisfaction degree of the user behavior with serial no 4 (PRV4) is:

$$P V R 4 = \frac{1}{1 + {e}^{- ( 1 \times 0.5 + 1 \times 0.67 + 0 \times 1 + 1 \times 1 )}} = 0.90$$

Thus, the satisfaction degree of each user behavior data recorded in the log file is predicted.

Further, in another example, according to the users and queries recorded in the user behavior data, the satisfaction degree of the user behavior data is normalized. The normalization may refer to adjustment of the satisfaction degree weight of the user behavior data according to the users or the queries to avoid errors of the satisfaction degree under different queries or users.

For example, in the log file, each user behavior data may include the user and the queries input by the user. The user behavior data related to the user reflects a personal preference of the user. For instance, different shopping habits of different users may affect the satisfaction degree of the user to the data object such that a male user often decides to purchase the product within a short period of time and further has a high satisfaction degree of the product while a female user often decides to purchase the product after a long period of time and further has a low satisfaction degree of the product. The user behavior data related to the same query may also reflect the characteristic of the query. For instance, different queries may reflect different shopping habits. When the user inputs a query word “dress,” the user often needs a lot of time to decide whether to purchase. When the user inputs a query word “sweet fit dress,” the user often needs less time to decide whether to purchase. Thus, the normalization of each user behavior data is conducted with respect to different query words and different users to eliminate the influences of different query words and different users to the user behavior data.

The normalization of the satisfaction degree of the user behavior data may be implemented through a formula (1.2).

PVR′=(PVR×PVR)÷(PVRq×PVRu) (1.2)

PVR′ represents the normalized satisfaction degree. PVR is the originally predicted satisfaction degree. PVRq is the average satisfaction degree of the query word q (i.e., the average value of the satisfaction degree of the user behavior data including the query word q). PVRu is the average satisfaction degree of the query word u (i.e., the average value of the satisfaction degree of the user behavior data including the query word u).

Using the four user behavior data listed in Table 1 as the example, the satisfaction degree of each user behavior data is normalized. The satisfaction degree of the user behavior data with serial no 1, i.e., PVR1, (the user U1, the query word Q1) is 0.96. The satisfaction degree of the user behavior data with serial no 2, i.e. PVR2, (the user U2, the query word Q1) is 0.76. The satisfaction degree of the user behavior data with serial no 3, i.e. PVR3, (the user U1, the query word Q2) is 0.62. The satisfaction degree of the user behavior data with serial no 4, i.e. PVR4, (the user U1, the query word Q2) is 0.90.

PVRQ1=(0.96+0.76)÷2=0.86

PVRQ2=(0.62+0.90)÷2=0.76

PVRU1=(0.96+0.62+0.90)÷3=0.83

PVRU2=0.76÷1=0.76

Through the calculation by the formula (1.2), the satisfaction degree of the user behavior data PVR1 is normalized as:

PVR1′=(PVR1×PVR1)÷(PVRQ1×PVRU1)=(0.96×0.96)÷(0.86×0.83)=1.29

The satisfaction degree of the user behavior data PVR2 is normalized as:

PVR2′=(PRV2×PRV2)÷(PVRQ1×PVRU2)=(0.76×0.76)÷(0.86×0.76)=0.88

The satisfaction degree of the user behavior data PVR3 is normalized as:

PVR3′=(PRV3×PRV3)÷(PVRQ2×PVRU1)=(0.62×0.62)÷(0.76×0.83)=0.61

The satisfaction degree of the user behavior data PVR4 is normalized as:

PVR4′=(PRV4×PRV4)÷(PVRQ2×PVRU1)=(0.90×0.90)÷(0.76×0.83)=1.28

At 120, a characteristic combination is formed by selecting one or more characteristics from a characteristic of the user and a characteristic of a data object corresponding to one or more user behaviors of the user in each user behavior data.

For example, the characteristic combination may be formed by the characteristic of the data object in one or more dimensions and the characteristic of the user in one or more dimensions.

The selected characteristic may be a single characteristic. At an e-commerce website, the data object is product information. The single characteristic may include a product attribute (such as a product price, a sale volume, a style, a brand, a type, etc.), a group label of the user (such as a gender, an age, a profession, a location, a shopping power, etc.), and an attribute of the query word (such as a query word-related type, brand, style, etc.)

The dimension of the data object may represent an attribute of the data object (individualized label). An attribute value of the data object is the characteristic of the data object in the dimension. For example, when the data object is the product, the dimensions of the product may be the product's price, sale volume, style, brand, type, etc. The characteristic of the style dimension of the data object may be sweet, ladylike, etc. The dimensions of the user may represent the attributes of the user (individualized label). The attribute value of the user is the characteristic of the user in the dimension. For example, the dimensions of the user may include the gender, age, profession, location, etc. The characteristic of the gender dimension of the user may be male or female. The characteristic of the data object and the characteristic of the user may be combined to form the characteristic combination. For example, the data object is soccer. The characteristic of soccer is sports. The characteristic of the user is male. The characteristic of the soccer and the characteristic of the user are combined to obtain a combination of sports (characteristic of soccer) and male (the characteristic of the user) and a combination of male (the characteristic of soccer) and male (the characteristic of the user).

The data object may be stored in the server in advance. The data object at the server is pre-analyzed to obtain the characteristic of the data object. If the user ever visited the server or the user already registered at the server, the visiting record or registration record (information) of the user is retained at the server. At the server, the visiting record or the registration record of the user is analyzed to obtain the dimensional characteristic of the user. According to the pre-stored characteristic of the user and the characteristic of the data object, the recorded characteristic of the user and the recorded characteristic of the data object are extracted from the user behavior data.

For example, the user behavior data records the users and the data objects as shown in Table 1. Thus, at the server side, the dimensional characteristic of the user and the dimensional characteristic of the data object are searched from the pre-stored dimensional characteristics of all data objects and dimensional characteristics of all users.

Further, each user may be assigned a unique user ID and each data object may be assigned a unique data object ID. The pre-stored characteristic of the data object corresponds to the data object ID of the data object. The pre-stored characteristic of the user corresponds to the user ID of the user. The user recorded in the user behavior data is replaced by the user ID. The recorded data object is replaced by the data object ID. The data object ID recorded in the user behavior data is matched with all of the pre-stored data object IDs to obtain a characteristic of the data object corresponding to the data object ID. The user ID recorded in the user behavior data is matched with all of the pre-stored user IDs to obtain a characteristic of the user corresponding to the user ID. Thus, the dimensions of the data objects and the dimensions of the user recorded in each user behavior data are obtained. For example, the query word input by the user may also have characteristic. The characteristic of the query word may represent an attribute value of the query word. For instance, the query word is soccer. The dimension of soccer is sports. The characteristic of soccer is male.

Further, the characteristic of the data object, the characteristic of the user, and the characteristic of the query word may be combined. The forms of combination may include a combination of the characteristic of the data object and the characteristic of the user, a combination of the characteristic of the user and the characteristic of the query word, and a combination of the characteristic of the data object, the characteristic of the user, and the characteristic of the query word. The characteristic combination is thus obtained.

At 130, according to the satisfaction degree of the user behavior data under each characteristic or characteristic combination, the individualized model is trained to obtain the individualized weight of the each characteristic or characteristic combination.

The individualized weight reflects an importance of each characteristic or characteristic combination in improving the satisfaction degree of the user to the data object. The user behavior data under the particular characteristic or characteristic combination refers to the user behavior data that has the particular characteristic or characteristic combination.

The satisfaction degree of the user behavior data under each characteristic or characteristic combination is used to conduct training of the individualized model and to further obtain a weight of each characteristic or characteristic combination that affects the satisfaction degree of the user behavior data (or individualized weight of the characteristic or characteristic combination).

One or more data objects are searched through the query word input by the user. The individualized model is used to estimate/predict the individualized score of each data object.

The individualized score represents an expectation value of the user to the data object. The higher the expectation value is, the higher the attention from the user to the data object is. The lower the expectation value is, the lower the attention from the user to the data object is.

The individualized model, according to the preferences of the user, calculates the individualized scores of the found data objects, and ranks the data objects according to the scores. The individualized ranking lists the data object that has the highest attention degree at the top of the search result and the data object that the user does not pay attention to at the end of the search result.

The satisfaction degree of the user behavior data recorded in the log file or the normalized satisfaction degree of the user behavior data may be used as the target. The characteristic or characteristic combination of the user and the data object recorded in the user behavior data is used as the characteristic of the training set to conduct the training of the individualized model. The individualized scores of the data objects recorded in the user behavior data of the training set are known (or pre-labeled). The predicted model is trained based on the characteristics of the training set. Through adjusting the parameter in the model, if the individualized score calculated from the model matches the known individualized score (such that they are equal or the difference is within a preset range), the model that obtains the correct individualized score is the individualized model through training.

For example, the characteristic combination is used to illustrate the processing of training the individualized model.

The individualized model includes the parameter of individualized weight. For instance, the individualized weight may represent the average value of the satisfaction degree of the user behavior data that includes the same characteristic combination. For instance, the log file includes four user behavior data. The products A1, A2, A3, and A4 are searched by the query word Q3 input by the user U1. The characteristic of the user U1 is searched. The characteristics of the data objects, i.e., the products A1, A2, A3, and A4, which are searched through the query word Q3 input by the user U1, are also searched. Further, the satisfaction degree model is trained according to the user behavior data and the satisfaction degree of each user is obtained. As shown in Table 2, the user characteristic of the user U1 is male, which represents that the user U1 is a male user. The data objects searched through the query word Q3 are the products A1, A2, A3, and A4. The characteristic of the data object A1 is male product. The characteristic of the data object A2 is female product. The characteristic of the data object A3 is female product. The characteristic of the data object A4 is male product. The characteristic of the user and the characteristic of the data object are combined to obtain the characteristic combination. According to other data recorded in the log file, such as occurrence times of each user behavior in the user behavior data, the satisfaction degree of each user behavior data is calculated. Such operations may refer to operations from 210 to 220. For the convenience of describing the training process of the individualized model, the satisfaction degree of each user behavior is directly listed in Table 2. For instance, the satisfaction degree of the user behavior data with serial no 5 is 0.5. The satisfaction degree of the user behavior data with serial no 6 is 0.6. The satisfaction degree of the user behavior data with serial no 7 is 2.4. The satisfaction degree of the user behavior data with serial no 8 is 1.5. The satisfaction degrees in Table 2 may also be the normalized satisfaction degrees of the user behavior data.

TABLE 2

| Ser. | Query | | Characteristic | Data | Characteristic | Characteristic | Satisfaction |
|---|---|---|---|---|---|---|---|
| No | Word | User | of User | Object | of Data Object | Combination | Degree |
| 5 | Q3 | U1 | Male | Product | Male Product | Male + Male | 0.5 |
| | | | | A1 | | Product | |
| 6 | Q3 | U1 | Male | Product | Female Product | Male + Female | 0.6 |
| | | | | A2 | | Product | |
| 7 | Q3 | U1 | Male | Product | Female Product | Male + Female | 2.4 |
| | | | | A3 | | Product | |
| 8 | Q3 | U1 | Male | Product | Male Product | Male + Male | 1.5 |
| | | | | A4 | | Product | |

The individualized weight of the characteristic of the data object with respect to the characteristic of the user (wg) may be the average value of the satisfaction degrees of the user behavior data with the same characteristic combination. The characteristic combinations listed in Table 2 include “Male+Male Product” and “Male+Female Product.” The individualized weight of the characteristic combination “Male+Male Product” is 1, which is the average values of the satisfaction degrees of the user behavior data with serial no 5 and serial no 8 ((0.5+1.5)/2=1). The individualized weight of the characteristic combination “Male+Female Product” is 1.5, which is the average values of the satisfaction degrees of the user behavior data with serial no 6 and serial no 7 ((0.6+2.4)/2=1.5).

The finally obtained individualized weight of the characteristic of each data object with respect to the characteristic of each user (as shown in Table 3) is stored to be used to rank the searched data objects in the data search.

TABLE 3

| Ser. | Query | | Characteristic | Data | Characteristic | Characteristic | Individualized |
|---|---|---|---|---|---|---|---|
| No | Word | User | of User | Object | of Data Object | Combination | Weight |
| 5 | Q3 | U1 | Male | Product | Male Product | Male + Male | 1 |
| | | | | A1 | | Product | |
| 6 | Q3 | U1 | Male | Product | Female Product | Male + Female | 1.5 |
| | | | | A2 | | Product | |
| 7 | Q3 | U1 | Male | Product | Female Product | Male + Female | 1.5 |
| | | | | A3 | | Product | |
| 8 | Q3 | U1 | Male | Product | Male Product | Male + Male | 1 |
| | | | | A4 | | Product | |

The individualized model is trained to obtain the individualized weight of the characteristic of the data object with respect to the characteristic of the user, which may be also implemented through the logical regression and decision tree. In other words, the logical regression algorithm or decision tree is used to train the individualized model to obtain the individualized weight. For example, the individualized weight may be the parameter in the individualized model. The model or algorithm accepted by the individualized model and the satisfaction degree model may be the same or different.

At 140, according to the individualized weight of the characteristic or the characteristic combination, the one or more data objects searched by the query word included in the search request are ranked and the one or more data objects are displayed according to the ranking.

The server receives the search request from the user. The search request includes the input query word. According to the query word, the server searches multiple data objects matching the query word from the massive amount of data objects. According to the individualized weights of the characteristic combinations obtained from the pre-trained individualized model, the multiple data objects are ranked to reflect different needs of different users to the data objects.

The characteristic of the user and the characteristic of each of the searched data objects are obtained from the pre-stored characteristic of the user and characteristics of the data objects. For example, when the query word is sent by the user, the user data may also be carried. The user data may include a user ID. The server, according to the analyzed user ID of the user, searches the characteristic of the user from the pre-stored characteristic of the user corresponding to the user ID. The server searches the characteristic of each of the matching data objects from the pre-stored characteristics of the data objects corresponding to the data object IDSs according to one or more data object IDs of the one or more data objects that match the query word.

The characteristic of the user and the characteristic of each matching data object are matched with the pre-trained individualized weight of the characteristic of the data object with respect to the characteristic of the user. For example, the found characteristic of the user is combined with the characteristic of each of the found data objects to obtain the characteristic combination. The stored item that has the same characteristic combination as the characteristic combination query is found according to stored individualized weight of the characteristic of the data object with respect to the characteristic of the user (or stored items as shown in Table 3). That is, the characteristic of the data object and the characteristic of the user in the stored item are the same as the found characteristic of the user and the found characteristic of the data object. The individualized weight of the stored item is used as the individualized weight of the characteristic of the corresponding data object with respect to the characteristic of the user.

For example, the user inputs the query word Q3 and finds the products A1, A2, A3, and A4. The characteristic of the user is male. The characteristic of the data object A1 is male product. The characteristic of the data object A2 is female product. The characteristic of the data object A3 is female product. The characteristic of the data object A4 is male product. The characteristic of the user and the characteristic of the data object are combined to obtain two characteristic combinations, i.e., “male+male product” and “male+female product.” Through the calculation of Table 2, the individualized weight data is obtained and stored, i.e., the individualized weight of “male+male product” is 1 and the individualized weight of “male+female product” is 1.5 as shown in Table 3. Thus, the characteristic of the user (male) and the characteristics of the data objects (the product A1: male product, the product A2: female product, the product A3: female product, the product A4: the male product) are combined to obtain two characteristic combinations for inquiry, i.e. “male+male product” and “male+female product.” The two characteristic combination queries are matched with the stored characteristic combinations in the individualized weight data to obtain that the individualized weight of the characteristic combination query “male+male product” is 1 and the individualized weight of the characteristic combination query “male+female product” is 1.5.

Through searching the individualized weight of the characteristic combination corresponding to the characteristic of the user and the characteristic of the found data object, the individualized score of the data object is predicted. The one or more data objects are ranked according to the individualized score of each of the data objects.

According to the individualized weight of the characteristic of the corresponding data object with respect to the characteristic of the user, the characteristic of the user, and the characteristic of the corresponding data object, the individualized score S of the corresponding data object is calculated. The individualized score of the data object represents the expectation value of the user to the data object, i.e., the preference degree of the user to the data object.

For example, the individualized score of each matching data object (S) may be calculated through a formula 1.3.

$$s = \frac{1}{1 + {e}^{- ( fg 1 \times wg 1 + fg 2 \times wg 2 + … + fgm \times wgm )}} \qquad ( 13 )$$

fg (fg1, fg2, . . . , fgm) represents a number of combinations (or characteristic combinations) of the characteristic of the same data object and the characteristic of the user in the user behavior data. wg (wg1, wg2, . . . , wgm) represents the individualized weight of the characteristic of the data object with respect to the characteristic of the user.

The formula (1.3) may be used as the individualized model. The individualized weight may be used as the parameter in the individualized model. Similar to the process of obtaining the satisfaction degree weight from training of the satisfaction degree model, the individualized weight is obtained through training of the individualized model.

The individualized score of each data object is predicted according to the individualized model. As shown in Table 3, according to the query word Q3 input by the user U1, four data objects are found, i.e., the products A1, A2, A3, and A4. In serial no 5, the number of combination “male+male product” is 1 and the individualized weight of the combination “male+male product” is 1. In serial no 6, the number of combination “male+female product” is 1 and the individualized weight of the combination “male+female product” is 1.5. In serial no 7, the number of combination “male+female product” is 1 and the individualized weight of the combination “male+female product” is 1.5. In serial no 8, the number of combination “male+male product” is 1 and the individualized weight of the combination “male+male product” is 1.

According to the formula (1.3), the individualized score of the product A1, A2, A3, and A4 is obtained respectively.

The individualized score of the product A1 is:

$$S 5 = \frac{1}{1 + {θ}^{- ( 1 \times 1 )}} = 0.73 .$$

The individualized score of the product A2 is:

$$S 6 = \frac{1}{1 + {θ}^{- ( 1 \times 1.5 )}} = 0.82 .$$

The individualized score of the product A3 is:

$$S 7 = \frac{1}{1 + {θ}^{- ( 1 \times 1.5 )}} = 0.82 .$$

The individualized score of the product A4 is:

$$S 8 = \frac{1}{1 + {θ}^{- ( 1 \times 1 )}} = 0.73 .$$

In one example, the individualized score of each data object is smoothed. The smooth processing may refer to control the individualized score of each data object within a predefined range. For example, the individualized score of the data object may be limited between 0.5 and 0.8. Thus, the individualized scores of the product A1 and the product A4 (0.73) are within the predefined range and are thus qualified. The individualized scores of the product A2 and the product A3 (0.82) are out of the predefined range. The individualized score 0.82 is smoothed within the predefined range. For instance, the individualized score 0.82 is changed to 0.8 that is close to the individualized score 0.82 and is within the predefined range.

Based on the individualized score of each matching data object, the multiple matching data objects are ranked.

For example, based on the individualized scores of the searched or found data objects products A1, A2, A3, and A4 are (0.73, 0.82, 0.82, 0.73). The products A1, A2, A3 and A4 are ranked.

As S5 and S8 are equal to 0.73 and S6 and S7 are equal to 0.82, the individualized scores of the products A1 and A4 are equal and the individualized scores of the products A2 and A3 are equal. The data objects that have the same individualized score may be randomly ranked to obtain a ranking result, the products A2, A3, A1, and A4.

The multiple searched data objects are displayed to the user according to the ranking result. For example, the multiple searched data objects are displayed according to an order of the individualized score from high to low.

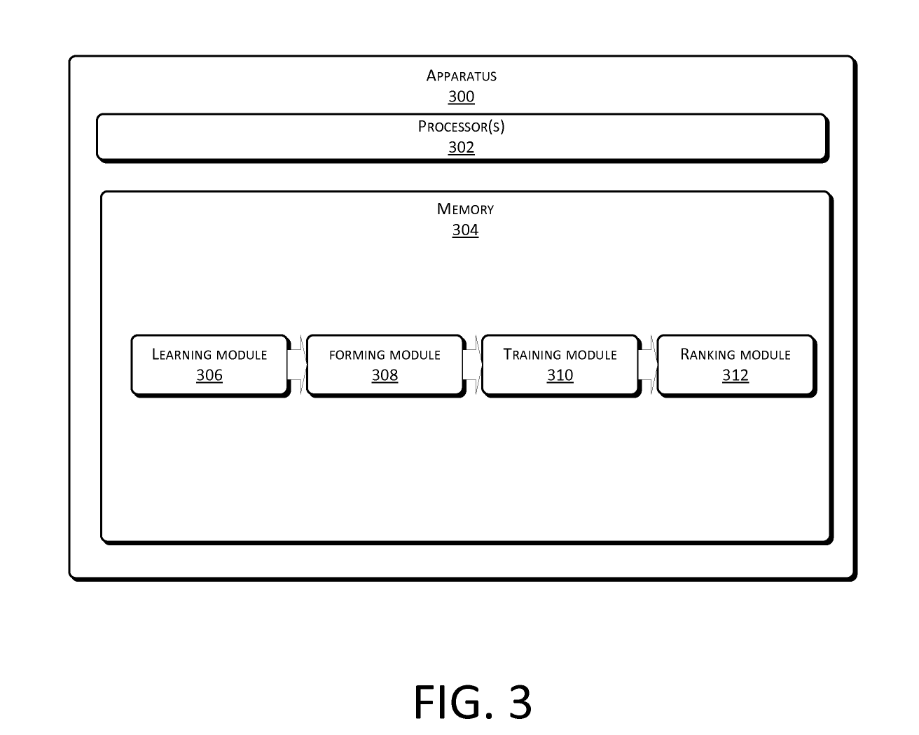

The present disclosure also provides an example data search apparatus as shown in FIG. 3. FIG. 3 is a diagram illustrating an example individualized data search apparatus 300 according to the present disclosure.

For example, the apparatus 300 may include one or more processor(s) 302 or data processing unit(s) and memory 304. The memory 304 is an example of computer-readable media. The memory 304 may store therein a plurality of modules including a learning module 306, a forming module 308, a training module 310, and a ranking module 312.

The learning module 306 conducts a machine learning according to user behavior data that records one or more user behaviors of a user to one or more data objects to obtain a satisfaction degree of each user behavior data. Each user behavior data may record at least the user, the one or more user behaviors of the user to the data object, the data object, and a query word corresponding to the data object.

The learning module 306 may further conduct the machine learning according to each user behavior of the recorded one or more user behaviors.

For example, the learning module 306 may include a training processing unit (not shown in FIG. 3) and a predicting processing unit (not shown in FIG. 3). The training processing unit conducts satisfaction degree model training according to each user behavior of the one or more user behaviors recorded in the user behavior data and determines a satisfaction degree weight of each user behavior. The detailed implementation process of the training processing unit may refer to the operations at 210. The predicting processing unit predicts a satisfaction degree of each user behavior data according to the satisfaction degree weight of each user behavior of the one or more user behaviors recorded in the user behavior data. The detailed implementation process of the predicting processing unit may refer to the operations at 220.

For example, the learning module 306 may normalize the satisfaction degree of each user behavior data according to the user and the query words recorded in each user behavior data. The detailed implementation process of the learning module may refer to the operations at 110.

The forming module 308 selects a characteristic of the user and one or more characteristics of one or more data objects in the user behavior data to form the characteristic combination.

For example, the forming module 308 may further obtain the characteristic of the user and the characteristic of data object recorded in each user behavior data according to pre-stored characteristic of the user and the characteristic of the data object. The detailed implementation process of the forming module 308 may refer to the operations at 120.

The training module 310 conducts individualized model training according to the satisfaction degree of the user behavior data under each characteristic or characteristic combination to obtain an individualized weight of each characteristic or characteristic combination.

For example, the training module 310 may further train the individualized weight of each data object corresponding to the characteristic of the user according to the satisfaction degree of each user behavior data and the characteristic of the data object and the characteristic of the user recorded in each user behavior data. The detailed implementation process of the training module 310 may refer to the operations at 130.

The ranking module 312 ranks one or more data objects searched according to a query word in a search request of the user based on the individualized weight of the characteristic or characteristic combination and displays the one or more searched data objects according to the ranking.

For example, the ranking module 312 may obtain the characteristic of the user based on the search request of the user and the characteristic of the data object based on the searched data object, predict an individualized score of each data object through searching an individualized weight of the corresponding characteristic combination combined by the characteristic of the user and the characteristic of each searched data object, and rank the one or more data objects based on the individualized score of each data object. The detailed implementation process of the ranking module 312 may refer to the operations at 140.

As the detailed implementations of each module in the apparatus 300 as shown in FIG. 3 correspond to the detailed implementation of the operations in the example methods of the present disclosure, and FIGS. 1 and 2 have provided detailed illustrations, the details of each module are not described herein for the purpose of clarity.

In a standard configuration, a computing device, such as the apparatus, as described in the present disclosure may include one or more central processing units (CPU), one or more input/output interfaces, one or more network interfaces, and memory.

The memory may include forms such as non-permanent memory, random access memory (RAM), and/or non-volatile memory such as read only memory (ROM) and flash random access memory (flash RAM) in the computer-readable media. The memory is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

It should be noted that the term “including,” “comprising,” or any variation thereof refers to non-exclusive inclusion so that a process, method, product, or device that includes a plurality of elements does not only include the plurality of elements but also any other element that is not expressly listed, or any element that is essential or inherent for such process, method, product, or device. Without more restriction, the elements defined by the phrase “including a . . . ” does not exclude that the process, method, product, or device includes another same element in addition to the element.

One of ordinary skill in the art would understand that the example embodiments may be presented in the form of a method, a system, or a computer software product. Thus, the present techniques may be implemented by hardware, computer software, or a combination thereof. In addition, the present techniques may be implemented as the computer software product that is in the form of one or more computer storage media (including, but is not limited to, disk, CD-ROM, or optical storage device) that include computer-executable or computer-readable instructions.

The above description describes the example embodiments of the present disclosure, which should not be used to limit the present disclosure. One of ordinary skill in the art may make any revisions or variations to the present techniques. Any change, equivalent replacement, or improvement without departing the spirit and scope of the present techniques shall still fall under the scope of the claims of the present disclosure.

What is claimed is:

1. A method comprising:
conducting a machine learning of user behavior data to obtain a satisfaction degree of the user behavior data;
selecting one or more characteristics from a characteristic of a user and a characteristic of a data object to form a characteristic combination;
conducting a training of an individualized model to obtain an individualized weight of a respective characteristic or the characteristic combination; and
ranking one or more data objects searched by a query word from a search request from the user according to the individualized weight of the respective characteristic or the characteristic combination for each of the one or more data objects.

2. The method of claim 1, further comprising displaying the one or more data objects according to a result of the ranking.

3. The method of claim 1, wherein the user behavior data records at least one of the user, the user behavior of the user to the data object, the data object, and a query word corresponding to the data object.

4. The method of claim 1, wherein the conducting the machine learning of the user behavior of the user to the data object that is recorded in the user behavior data to obtain the satisfaction degree of the user behavior data comprises conducting the machine learning according to each user behavior of one or more recorded user behaviors.

5. The method of claim 1, wherein the conducting the machine learning of the user behavior of the user to the data object that is recorded in the user behavior data to obtain the satisfaction degree of the user behavior data comprises conducting a training processing and conducting a predicting processing.

6. The method of claim 5, wherein the conducting the training processing comprises:
conducting a training of a satisfaction degree model according to a respective user behavior of one or more user behaviors recorded in the user behavior data; and
determining a satisfaction degree weight of the respective user behavior.

7. The method of claim 6, wherein the conducting the predicting processing comprises predicting the satisfaction degree of the user behavior data at least according to the satisfaction degree weight of the respective user behavior.

8. The method of claim 1, the conducting the machine learning of the user behavior of the user to the data object that is recorded in the user behavior data to obtain the satisfaction degree of the user behavior data comprises normalizing the satisfaction degree of the user behavior data according to the user and the query word recorded in the user behavior data.

9. The method of claim 1, wherein the selecting the one or more characteristics from the characteristic of the user and the characteristic of the data object to form the characteristic combination comprises obtaining the characteristic of the user and the characteristic of the data object according to pre-stored characteristic of the user and characteristic of the data object.

10. The method of claim 1, wherein the conducting the training of the individualized model to obtain the individualized weight of the respective characteristic or the characteristic combination comprises training the individualized weight of the characteristic of the data object to the characteristic of the user according to the satisfaction degree of the user behavior data, the characteristic of the user, and the characteristic of the data object.

11. The method of claim 1, wherein the ranking the one or more data objects searched by the query word from the search request from the user according to the individualized weight of the respective characteristic or the characteristic combination comprises:
obtaining the characteristic of the user;
obtaining the characteristic of the data object;
predicting an individualized score of the data object by inquiring the individualized weight of the characteristic combination corresponding to the characteristic of the user and the characteristic of the data object; and
ranking the searched one or more data objects according to the individualized score of each of the one or more data objects.

12. An apparatus comprising:
a learning module that conducts a machine learning of a user behavior of user behavior data to obtain a satisfaction degree of the user behavior data;
a forming module that selects one or more characteristics from a characteristic of a user and a characteristic of a data object to form a characteristic combination;
a training module that conducts a training of an individualized model to obtain an individualized weight of a respective characteristic or the characteristic combination; and
a ranking module that ranks one or more data objects searched by a query word from a search request from the user according to the individualized weight of the respective characteristic or the characteristic combination for each of the one or more data objects.

13. The apparatus of claim 12, wherein the ranking module further displays the one or more data objects according to a result of the ranking.

14. The apparatus of claim 12, wherein the user behavior data records at least one of the user, the user behavior of the user to the data object, the data object, and a query word corresponding to the data object.

15. The apparatus of claim 12, wherein the learning module further conducts the machine learning according to each user behavior of one or more recorded user behaviors.

16. The apparatus of claim 12, wherein the learning module comprises a training processing unit and a predicting processing unit,
wherein:
the training processing unit conducts a training of a satisfaction degree model according to a respective user behavior of one or more user behaviors recorded in the user behavior data and determines a satisfaction degree weight of the respective user behavior; and
the predicting processing unit predicts the satisfaction degree of the user behavior data according to the satisfaction degree weight of the respective user behavior.

17. The apparatus of claim 12, wherein the learning module further normalizes the satisfaction degree of the user behavior data according to the user and the query word recorded in the user behavior data.

18. The apparatus of claim 12, wherein:
the forming module further obtains the characteristic of the user and the characteristic of the data object according to pre-stored characteristic of the user and characteristic of the data object; and
the training module further trains the individualized weight of the characteristic of the data object to the characteristic of the user according to the satisfaction degree of the user behavior data, the characteristic of the user, and the characteristic of the data object.

19. The apparatus of claim 12, wherein the ranking module further:
obtains the characteristic of the user;
obtains the characteristic of the data object;
predicts an individualized score of the data object by inquiring the individualized weight of the characteristic combination corresponding to the characteristic of the user and the characteristic of the data object; and
ranks the searched one or more data objects according to the individualized score of each of the one or more data objects.

20. One or more memories stored thereon computer-executable instructions executable by one or more processors to perform operations comprising:
conducting a machine learning of a user behavior of a user to a data object that is recorded in user behavior data to obtain a satisfaction degree of the user behavior data;
selecting one or more characteristics from a characteristic of the user and a characteristic of the data object to form a characteristic combination;
conducting a training of an individualized model to obtain an individualized weight of a respective characteristic or the characteristic combination; and
ranking one or more data objects searched by a query word from a search request from the user according to the individualized weight of the respective characteristic or the characteristic combination for each of the one or more data objects.
